(19) United States
(12) Patent Application Publication
(10) Pub. No.: US 2024/0382897 A1
(43) Pub. Date: Nov. 21, 2024

(54) APPARATUS AND METHOD FOR CARBON CAPTURE VIA ELECTROCHEMICAL-MEMBRANE SEPARATION

(71) Applicant: University of Kentucky Research Foundation, Lexington, KY (US)

(72) Inventors: Xin Gao, Lexington, KY (US); Ayokunle Omosebi, Lexington, KY (US); Kunlei Liu, Lexington, KY (US)

(21) Appl. No.: 18/665,035

(22) Filed: May 15, 2024

Related U.S. Application Data
(60) Provisional application No. 63/466,548, filed on May 15, 2023.

(51) Int. Cl. B01D 53/14; B01D 53/18; B01D 53/32; B01D 53/62; B01D 53/77

(52) U.S. Cl. CPC B01D 53/1475; B01D 53/1431; B01D 53/18; B01D 53/326; B01D 53/62; B01D 53/77; B01D 2252/10; B01D 2257/504

(57) ABSTRACT

An apparatus for capturing carbon dioxide from an untreated gas stream includes (a) an electrochemical unit adapted for generating an inorganic acid and a CO₂-free inorganic solvent, (b) an absorber in communication with the electrochemical unit, the absorber adapted for receiving the untreated gas stream and the CO₂-free inorganic solvent and capturing the carbon dioxide in the untreated gas stream as a CO₂-rich inorganic solvent, and (c) a mixing tank in communication with the electrochemical unit and the absorber, the mixing tank adapted for mixing the inorganic acid, received from the electrochemical unit, with the CO₂-rich inorganic solvent, received from the absorber, and releasing carbon dioxide by acid-base neutralization.

### RELATED APPLICATION

This application claims the benefit of U.S. Provisional Patent Application Ser. No. 63/466,548, filed on May 15, 2023, the full disclosure of which is incorporated herein by reference.

### TECHNICAL FIELD

This document relates generally to the capture of carbon dioxide from an air or acid gas stream and, more particularly, to a new and improved apparatus and method for carbon capture by means of electrochemical-membrane separation.

### BACKGROUND

The cleanup of acid gasses, such as CO₂, from industrial processes is a long-practiced technology. This cleanup is done for technical, environmental, and/or regulatory reasons. This document relates to an apparatus and related method for more efficient and effective carbon capture from air and industrial gas streams via electrochemical-membrane separation.

### SUMMARY

In accordance with the purposes and benefits set forth herein, a new and improved apparatus is provided for capturing carbon dioxide from an untreated gas stream. That apparatus comprises, consists of or consists essentially of: (a) an electrochemical unit, (b) an absorber in communication with the electrochemical unit, and (c) a mixing tank in communication with the electrochemical unit and the absorber. The electrochemical unit is adapted for generating an inorganic acid and a CO₂-free inorganic solvent. The absorber is adapted for receiving the untreated gas stream and the CO₂-free inorganic solvent and capturing the carbon dioxide in the untreated gas stream as a CO₂-rich inorganic solvent. The mixing tank is adapted for mixing the inorganic acid, received from the electrochemical unit, with the CO₂-rich inorganic solvent, received from the absorber, releasing carbon dioxide by acid-base neutralization.

The apparatus may further include a nanofiltration unit between the absorber and the mixing tank. The nanofiltration unit may be adapted to (a) separate the CO₂-rich inorganic solvent received from the absorber and (b) direct the CO₂-rich inorganic solvent to the mixing tank and the CO₂-free solvent back to the absorber.

One or more embodiments of the apparatus may further include a first spray unit in the absorber adapted for receiving and spraying the CO₂-free inorganic solvent from the electrochemical unit and a second spray unit in the absorber adapted for receiving and spraying the CO₂-free inorganic solvent from the nanofiltration unit.

The electrochemical unit of the apparatus may include (a) an anode, (b) a cathode, (c) a cation exchange membrane separating the anode from the cathode and (d) a voltage source connected to the anode and the cathode. In at least some embodiments, the electrochemical unit further includes (a) an anolyte tank and (b) a first pump adapted for circulating an anolyte from the anolyte tank across the anode and back to the anolyte tank. In at least some embodiments, the electrochemical unit further includes (a) a catholyte tank and (b) a second pump adapted for circulating a catholyte from the catholyte tank across the cathode and back to the catholyte tank. The electrochemical unit may be a sulfate-based electrochemical flow cell.

Some embodiments of the apparatus may further include a third pump, adapted for pumping the CO₂-free inorganic solvent from the catholyte tank to the absorber, and a fourth pump, adapted for pumping CO₂-rich inorganic solvent from the absorber to the mixing tank. Still further, some embodiments of the apparatus may further include a fifth pump adapted for recirculating the CO₂-free inorganic solvent at a lower end of the absorber to the second spray unit and a sixth pump adapted for pumping the CO₂-free inorganic solvent separated by the nanofiltration unit back to the second spray unit. Still further, the apparatus may further include a seventh pump, adapted for pumping the inorganic acid from the anolyte tank to the mixing tank and an eighth pump, adapted for pumping regenerated anolyte from the mixing tank to the anolyte tank.

The apparatus may further include (a) a first condenser connected to the anolyte tank and adapted for condensing water vapor from an oxygen discharge stream, (b) a second condenser connected to the catholyte tank and adapted for condensing water vapor from a hydrogen discharge stream and (c) a ninth pump adapted for pumping condensed water from the first condenser to the second condenser. The apparatus may further include (a) a first heating element, in the anolyte tank, adapted for heating the anolyte to a temperature of about 100° C. and (b) a second heating element, in the catholyte tank, adapted for heating the catholyte to a temperature of about 70° C.

In at least some of the many possible embodiments of the apparatus, the apparatus further includes a control system including a controller adapted to (a) receive data from a plurality of pressure sensors, a plurality of pressure regulators and a plurality of pH sensors and (b) control operation of the pumps in response to the data.

In accordance with an additional aspect, a method is provided for capturing carbon dioxide from an acid gas. That method comprises, consists of or consists essentially of the steps of: (a) generating an inorganic acid and a CO₂-free inorganic solvent with an electrochemical unit, (b) capturing the carbon dioxide in the acid gas as a CO₂-rich inorganic solvent in an absorber using the CO₂-free inorganic solvent from the electrochemical unit, and (c) mixing the inorganic acid from the electrochemical unit with the CO₂-rich inorganic solvent from the absorber and releasing carbon dioxide by acid-base neutralization.

In at least some embodiments, the method further includes one or more of the following steps:
(a) separating remaining CO₂-free inorganic solvent from the CO₂-rich inorganic solvent discharged from the absorber in a nanofiltration unit prior to circulating the CO₂-rich inorganic solvent to the mixing unit;
(b) recirculating the CO₂-free inorganic solvent separated by the nanofiltration unit back to the absorber;
(c) spraying the CO₂-free inorganic solvent from the electrochemical unit from a first spray unit in the absorber and spraying the CO₂-free inorganic solvent separated by the nanofiltration unit from a second spray unit in the absorber;
(d) using a sulfate-based electrochemical flow cell as the electrochemical unit; and
(e) heating anolyte in an anolyte tank to a temperature of about 100° C. and heating catholyte in a catholyte tank to a temperature of about 70° C.

In the following description, there are shown and described several different embodiments of the new and improved (a) apparatus for capturing carbon dioxide from an untreated gas stream and (b) related method of capturing carbon dioxide from an acid gas. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the apparatus and method and together with the description serve to explain certain principles thereof. A person of ordinary skill in the art will readily recognize from the following discussion that alternative embodiments of the illustrated structures and methods may be employed without departing from the principles described below.

FIG. 1 is a schematic illustration of the apparatus for capturing carbon dioxide from an air, industrial or acid gas stream.

FIG. 1A is a schematic illustration of the control system of the apparatus illustrated in FIG. 1.

FIG. 2 is a graph demonstrating the pH swing due to the formation of H₂SO₄ and KOH. The starting electrolyte was 2.5M K₂SO₄.

FIG. 3 is a graph demonstrating carbon removal from air using the OH⁻ produced at the cathode as demonstrated in FIG. 2.

FIG. 4 is an illustration of the acid-based neutralization for CO₂ release following from the tests as depicted in FIG. 3.

Reference will now be made in detail to the present preferred embodiments of the apparatus and method.

### DETAILED DESCRIPTION

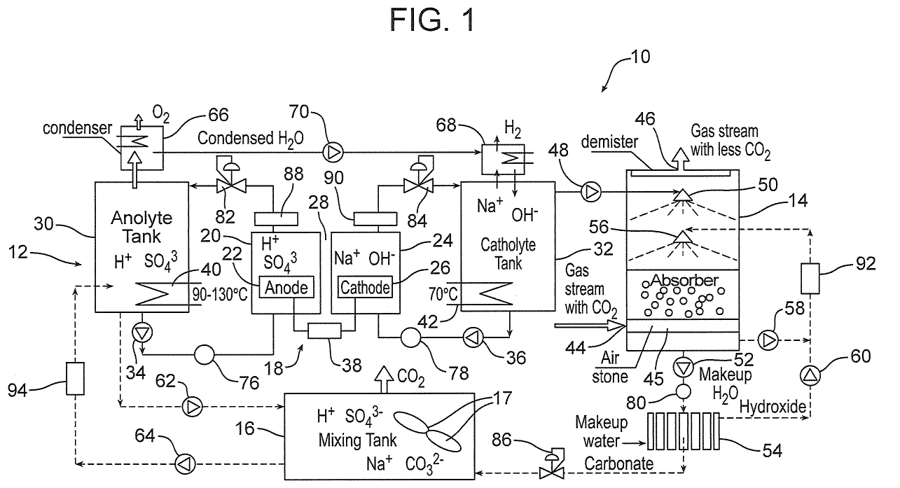

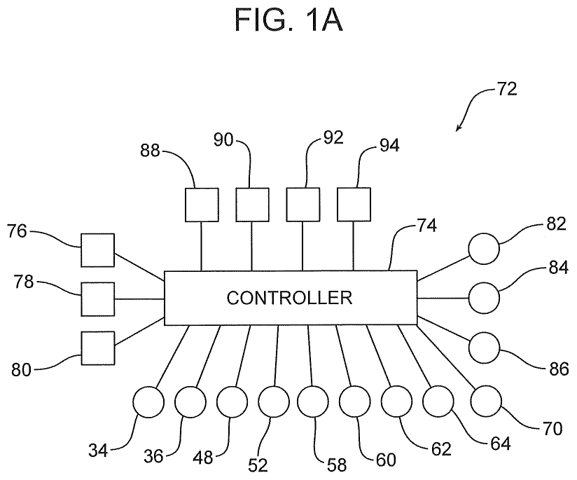

Reference is now made to FIGS. 1 and 1A which schematically illustrate the new and improved apparatus 10 for capturing carbon dioxide (CO₂) from an untreated gas stream such as an air stream, industrial gas stream or acid gas stream. Such an acid gas stream may be produced by power generation plants, cement producers, steel manufacturers and the like from burning coal, fuel pellets, biomass and natural gas.

As illustrated, the apparatus 10 generally includes an electrochemical unit 12, an absorber 14 and a mixing tank 16. As described in greater detail below, the electrochemical unit 12 is adapted for generating an inorganic acid (such as sulfuric acid (H₂SO₄)) and a CO₂-free inorganic solvent (such as sodium hydroxide (NaOH), potassium hydroxide (KOH), lithium hydroxide (LiOH) and mixtures thereof). This is accomplished through water hydrolysis and the generation of hydrogen ions (H⁺) at the anode and hydroxide ions (OH⁻) at the cathode.

The absorber 14 is adapted for receiving the untreated gas stream and the CO₂-free inorganic solvent and capturing the carbon dioxide in the gas stream with the inorganic solvent forming a CO₂-rich inorganic solvent (such as sodium carbonate (Na₂CO₃), potassium carbonate (K₂CO₃), lithium carbonate (Li₂CO₃) and mixtures thereof). The mixing tank 16 is adapted for mixing the inorganic acid, received from the electrochemical unit 12, with the CO₂-rich inorganic solvent, received from the absorber 14, and then releasing carbon dioxide by acid-base neutralization. Note agitator 17 adapted for stirring the contents of the mixing tank 16.

More specifically, the electrochemical unit 12 of the illustrated embodiment comprises a sulfate-based electrochemical flow cell 18 including (a) an anode compartment 20, housing an anode 22 (such as a dimensionless stable anode or any anticorrosive anode), (b) a cathode compartment 24, housing a cathode 26 (such as a stainless-steel cathode or any metal electrodes facilitating hydrogen evolution) and a cation exchange membrane 28 (of a type known in the art) separating (a) the anode and anode compartment from (b) the cathode and cathode compartment. An anolyte tank 30 provides a reservoir for an anolyte (e.g. sodium sulfate (Na₂SO₄), potassium sulfate (K₂SO₄), lithium sulfate (Li₂SO₄) or mixtures thereof) and a catholyte tank 32 provides a reservoir for a catholyte (e.g. NaOH, KOH, LiOH and mixtures thereof). A first pump 34 circulates the anolyte from the anolyte tank 30 over the anode 22 in the anode compartment 20 and back to the anolyte tank. A second pump 36 circulates the catholyte from the catholyte tank 32 over the cathode 26 in the cathode compartment 20 and back to the catholyte tank.

A voltage source 38, is connected to the anode 22 and the cathode 26. By applying either a current or voltage across the anode 22 and cathode 26, e.g., 500-50000 A/m² or 2-5 V, metal ions, e.g., Na′, K′, and Li′, are expulsed from the anode compartment 20, resulting in the production of H₂SO₄ at pH of <2. At the cathode compartment 24, the transferred metal ions are commingled with OH⁻ produced from water electrolysis, turning into NaOH, KOH, LiOH, or a mixture thereof.

A first heating element 40 in the anolyte tank 30 is provided for heating the anolyte in the anolyte tank to a desired temperature of, for example about 100° C. A second heating element 42 in the catholyte tank 32 is provided for heating the catholyte in the catholyte tank to a desired temperature of, for example about 70° C. This heating of the anolyte and the catholyte functions to reduce the energy consumption of the electrochemical process by greater than 20%: that is reduces the operating cell voltage or enlarging output current for gas evolution reactions according to the Arrhenius equation thereby improving the reduction kinetics by increasing temperature.

The absorber 14 includes an untreated gas stream inlet 44 adjacent a lower end thereof and a treated gas stream outlet 46 adjacent an upper end thereof. A third pump 48 pumps CO₂-free inorganic solvent (NaOH, KOH, LiOH, or a mixture thereof), generated at the cathode 26 and collected in the catholyte tank 32, from the catholyte tank to a first spray unit 50 in the absorber 14. The CO₂-free inorganic solvent from the spray unit 50 moves downward through the absorber 14 in countercurrent flow to the untreated gas moving upward toward the treated gas stream outlet 46. As a result, carbon dioxide in the untreated gas stream is captured through reaction with the CO₂-free inorganic solvent to form a CO₂-rich inorganic solvent (such as sodium carbonate (Na₂CO₃), potassium carbonate (K₂CO₃), lithium carbonate (Li₂CO₃) and mixtures thereof). The treated gas stream, with less carbon dioxide, is discharged from the absorber at the outlet 46.

At the same time, the CO₂-rich inorganic solvent, settling to the bottom of the absorber 14, is pumped by a fourth pump 52 to a nanofiltration unit 54 that is situated between the absorber and the mixing tank 16. The nanofiltration unit 54 is adapted to separate the CO₂-rich inorganic solvent from any remaining CO₂-free inorganic solvent. This CO₂-free inorganic solvent or OH⁻ recovery advantageously reduces the energy consumption for OH⁻ generation in the electrochemical unit 12.

The CO₂-rich inorganic solvent is then directed to the mixing tank 16. The relatively lighter CO₂-free inorganic solvent, collecting at the bottom of the absorber 14, and the CO₂-free inorganic solvent separated by the nanofiltration unit 54, is recycled to a second spray unit 56 in the absorber by the respective fifth pump 58 and sixth pump 60. Note the second spray unit 56 is located in the absorber below the first spray unit 50 closer to the acid gas stream inlet 44 thereby providing a two-layer nozzle spray for enhanced carbon dioxide capture.

A seventh pump 62 is adapted for pumping the inorganic acid generated at the anode 22 and collected in the anolyte tank 30 from the anolyte tank to the mixing tank 16. An eighth pump 64 is adapted for pumping anolyte regenerated in the mixing tank 16 from the mixing tank to the anolyte tank 30 for later conversion at the anode 22 into the inorganic acid.

The apparatus 10 also includes a first condenser 66 connected to the anolyte tank 30. The condenser 66 is adapted for condensing water vapor from an oxygen discharge stream. Still further, the apparatus 10 includes a second condenser 68 connected to the catholyte tank 32. The second condenser 68 is adapted for condensing water vapor from a hydrogen discharge stream. The condensers 66, 68 function to minimize the volume of freshwater intake. The condensed water may be returned to the electrolyte tanks 30, 32 or used as a carrier to promote OH⁻ permeability of the NF unit 54 membrane. The produced gas (oxygen and hydrogen) is collected (or can be pressurized) for sales or beneficial uses, e.g., hydrogen may be used to produce higher value chemicals. A ninth pump 70 is adapted for pumping condensed water from the first condenser 66 to the second condenser 68 to provide balance between the anode loop and the cathode loop and sustain the solvent volume that is supplied to the absorber 14.

Finally, the apparatus 10 may also include a control system, generally designated in FIG. 1A by reference number 72. The control system 72 includes a controller 74 or computing device that is adapted to (a) receive data from a plurality of pressure sensors 76, 78 and 80, a plurality of pressure regulators 82, 84 and 86 and a plurality of pH sensors 88, 90, 92 and 94 and (b) control operation of the pumps 34, 36, 48, 52, 58, 60, 62, 64 and 70 in response to the data. The controller 74 may also control operation of one or more of the voltage source 38, the first heating element 40 and the second heating element 42.

In the illustrated embodiment, the first pressure sensor 76 is located downstream of the anolyte tank 30 and upstream of the anode compartment 20 and the second pressure sensor 78 is located downstream of the catholyte tank 32 and upstream of the cathode compartment 24. The third pressure sensor 80 is located downstream of the absorber 14 and upstream of the nanofiltration unit 54.

The first pressure regulator 82 is located downstream of the anode compartment 20 and upstream of the anolyte tank 30. The second pressure regulator 84 is located downstream of the cathode compartment 24 and upstream of the catholyte tank 32. The third pressure regulator 86 is located downstream of the nanofiltration unit 54 and upstream of the mixing tank 16.

The first pH sensor 88 is located downstream of the anode compartment 20 and upstream of the anolyte tank 30. The second pH sensor 90 is located downstream of the cathode compartment 24 and upstream of the catholyte tank 32. The third pH sensor 92 is located downstream of the fifth pump 58 and upstream of the second spray unit 56 while the fourth pH sensor 94 is located downstream of the mixing tank 16 and upstream of the anolyte tank 30.

The pressure regulators 82 and 84 at the electrode compartment 20, 24 outlets reduce the energy consumption of the electrochemical process and water transfer between anode and cathode loops. The pressure loaded onto the electrode chambers between 30 and 150 psig compresses the sizes of gas bubbles, therefore decreasing the gas space to reduce the operating cell voltage or enlarging output current for gas evolution reactions. Moreover, utilizing the pressure difference between the anode and cathode chambers can control the direction of water transportation, e.g., if pressure at the anode chamber is greater than that for the cathode chamber, water will cross the membrane 28 from the anode to cathode chambers 20, 24, which is another way to sustain the solvent volume that is supplied to the absorber 14.

The apparatus 10 may be used in a method of capturing carbon dioxide from an untreated gas stream. That method may be described as including the steps of: (a) generating an inorganic acid and a CO₂-free inorganic solvent with an electrochemical unit 12, (b) capturing the carbon dioxide in the acid gas as a CO₂-rich inorganic solvent in an absorber 14 using the CO₂-free inorganic solvent from the electrochemical unit and (c) mixing the inorganic acid from the electrochemical unit with the CO₂-rich inorganic solvent from the absorber, releasing carbon dioxide by acid-base neutralization in a mixing unit 16.

The method may further include the step of separating any remaining CO₂-free inorganic solvent from the CO₂-rich inorganic solvent discharged from the absorber 14 in a nanofiltration unit 54 prior to circulating the CO₂-rich inorganic solvent to the mixing unit 16. The method may also include any one or more of the following additional steps: (a) recirculating the CO₂-free inorganic solvent separated by the nanofiltration unit 54 back to the absorber 14, (b) spraying the CO₂-free inorganic solvent from the electrochemical unit 12 from a first spray unit 50 in the absorber and spraying the CO₂-free inorganic solvent separated by the nanofiltration unit from a second spray unit 56 in the absorber, (c) using a sulfate-based electrochemical flow cell 18 as the electrochemical unit, (d) heating anolyte in an anolyte tank 30 to a temperature of about 100° C. and (c) heating a catholyte in a catholyte tank 32 to a temperature of about 70° C.

The absorber 14 incorporates a number of design features that provide various benefits and advantages. The absorber 14 provides gas-liquid countercurrent flow with two-level spray adapted to maximize CO₂ separation from flue gas or air, as CO₂ concentration decreases from the bottom to top, and alkalinity decreases from the top to bottom. As depicted in FIG. 1, flue gas or air enters the bottom of the absorber 14, where a gas distributor 45 (e.g., bubble cap tray, air stone) may or may not be used to enlarge the contact area of gas and solvent for initial CO₂ capture. Subsequently, gas leaves from the liquid solvent followed by capturing the remaining CO₂ via the lower-level spray from spray unit 56. Finally, gas is polished by using the freshly produced NaOH, KOH, LiOH, or mixture thereof by the upper-level spray from spray unit 50, where the freshly produced solvent comes from the catholyte tank 32.

By coupling the absorber 14 with the nanofiltration unit 54, it is possible to reduce the energy consumption and absorber size, especially for the low CO₂ concentration capture. The nanofiltration unit 54 is used to separate the reacted OH⁻, monovalent species, from CO₃²⁻, divalent species, at 200-600 psig. Under such a condition, the recovered OH⁻ from the permeate is circulated via pump 60 to the lower-level spray unit 56 for a secondary CO₂ capture while nearly 100% CO₃²⁻ from the reject is pumped into a mixing tank 16. To improve the OH⁻ separation, the system makeup water and/or condensate water from gas-liquid separators installed at anode and/or cathode tanks will be used as sweeping carrier fed to nanofilter membrane in the counter-current pattern with carbon-contained stream from absorber bottom. In comparison to a conventional nanofiltration unit, the nanofiltration unit 54 utilized in this process has two inlets, one for CO₃²⁻ mixed with OH⁻ and one for condensed and/or makeup water, and two outlets, one for CO₃²⁻ inject and one for OH⁻ permeate.

In the mixing tank 16, Na₂CO₃, K₂CO₃, Li₂CO₃, or mixture thereof from the reject of the nanofiltration unit 54 reacts natively with warm H₂SO₄ (e.g., 40-60° C.) from the anolyte tank 30 (associated with the electrochemical flow cell 12) under agitation. As a result, pure CO₂ is attained from the top of the mixing tank for beneficial uses, e.g., making synthetical fuels, food additives, etc. The liquid product of Na₂SO₄, K₂SO₄, Li₂SO₄, or mixture thereof is pumped via pump 64 to the anolyte tank 30 for H₂SO₄ production, as described above.

### EXPERIMENTAL

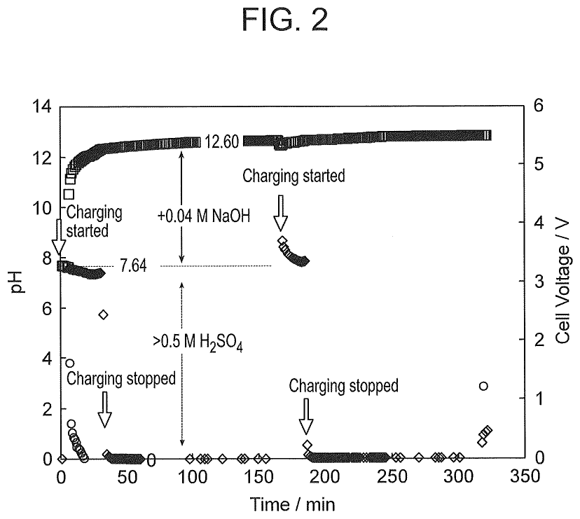

An experimental lab-scale apparatus 10 was constructed using a bubbling, stainless-steel sparger in the place of the spray absorber 14. Results using that experimental apparatus demonstrate that the use of an electrochemical flow cell, configured with a pair of nickel-based metal electrodes separated by a Nafion 117 membrane, achieves a great pH difference between the catalyte and the anolyte as a result of water electrolysis toward oxygen and hydrogen evolutions when using a K₂SO₄ solution. See FIG. 2.

As shown, the pH of the catolyte increases to 12.60 from 7.64, suggesting the formation of KOH at the cathode; and the pH of the anolyte decreases to unmeasurable, suggesting the formation of H₂SO₄ at the anode. Under such conditions, the higher pH solution is available for CO₂ capture while the lower pH solution is used for acid-base neutralization toward CO₂ release as described above. In addition, the pH of the catholyte can be further enlarged by changing the operating conditions such as increasing the charging current and reducing the liquid flow rate.

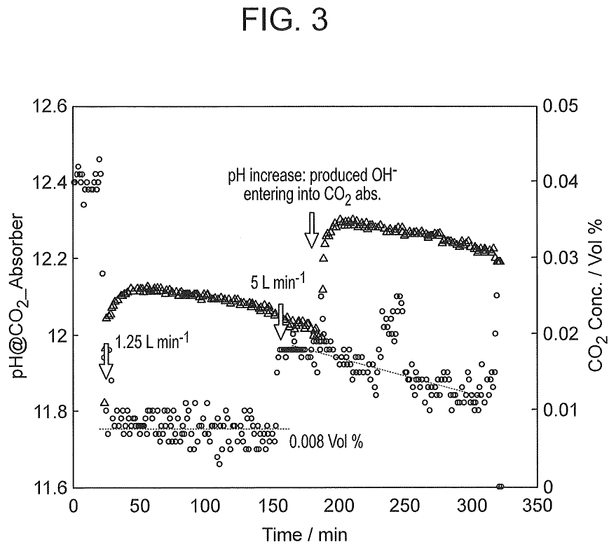

Given the conditioned pH of the liquid shown in FIG. 2, direct air capture was used to demonstrate the carbon capture using the alkaline solution produced from the cathode of the electrochemical flow cell. As shown in FIG. 3, initially the pH of the liquid in the absorber increased to approximately 12.1, leading to the CO₂ capture rate of 80%, computed as 0.008 Vol % divided by 0.04 Vol %, when the airflow rate was 1.25 L min⁻¹. At about 200 minutes, the second pH increase to 12.3 is caused by pumping the newly produced KOH into the absorber as reflected in FIG. 2. However, such a mild increase in the pH cannot sustain the high carbon capture rate, e.g. >80%, when the airflow rate increases significantly from 1.25 to 5 L min⁻¹. Under such a condition, increases in the pH of the catolyte may be a way, which can be achieved by increasing the applied current or voltage to the electrochemical flow cell.

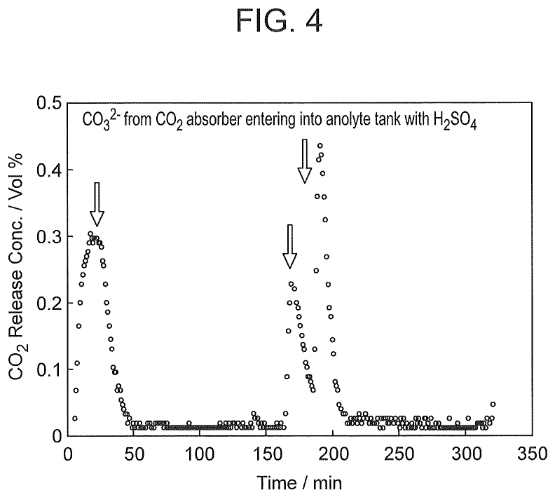

Following the test as shown in FIG. 2, the carbon rich capture solvent, K₂CO₃, was delivered to the anolyte tank, in which H₂SO₄ is ready to react with K₂CO₃ producing CO₂, H₂O, and K₂SO₄ via: K₂CO₃+H₂SO₄→K₂SO₄+CO₂+H₂O. As shown in FIG. 4, the peaks due to the CO₂ release were measured by a CO₂ analyzer with a consistent flowrate of nitrogen as dilution carry gas to meet the gas analyzer measuring range when mixing H₂SO₄ with K₂CO₃. The pure CO₂ may be collected for beneficial uses and the H₂O and K₂SO₄ may be recycled to produce H₂SO₄.

This document may be said to relate to the following items:
1. An apparatus for capturing carbon dioxide from an untreated gas stream, comprising:
   an electrochemical unit adapted for generating an inorganic acid and a CO₂-free inorganic solvent;
   an absorber in communication with the electrochemical unit, the absorber adapted for receiving the untreated gas stream and the CO₂-free inorganic solvent and capturing the carbon dioxide in the untreated gas stream as a CO₂-rich inorganic solvent; and
   a mixing tank in communication with the electrochemical unit and the absorber, the mixing tank adapted for mixing the inorganic acid, received from the electrochemical unit, with the CO₂-rich inorganic solvent, received from the absorber, releasing carbon dioxide by acid-base neutralization.
2. The apparatus of item 1, further including a nanofiltration unit between the absorber and the mixing tank, the nanofiltration unit being adapted to (a) separate the CO₂-rich inorganic solvent received from the absorber and (b) direct the CO₂-rich inorganic solvent to the mixing tank and the CO₂-free or CO₂-lean inorganic solvent back to the absorber.
3. The apparatus of item 2, further including a first spray unit in the absorber adapted for receiving and spraying the CO₂-free inorganic solvent from the electrochemical unit and a second spray unit in the absorber adapted for receiving and spraying the CO₂-free inorganic solvent from the nanofiltration unit.
4. The apparatus of item 3, wherein the electrochemical unit includes (a) an anode, (b) a cathode, (c) a cation exchange membrane separating the anode from the cathode and (d) a voltage source connected to the anode and the cathode.
5. The apparatus of item 4, wherein the electrochemical unit further includes (a) an anolyte tank and (b) a first pump adapted for circulating an anolyte from the anolyte tank across the anode and back to the anolyte tank.
6. The apparatus of item 5, wherein the electrochemical unit further includes (a) a catholyte tank and (b) a second pump adapted for circulating a catholyte from the catholyte tank across the cathode and back to the catholyte tank.
7. The apparatus of item 6, further including a third pump, adapted for pumping the CO₂-free inorganic solvent from the catholyte tank to the absorber, and a fourth pump, adapted for pumping CO₂-rich inorganic solvent from the absorber to the mixing tank.
8. The apparatus of item 7, further including a fifth pump adapted for recirculating the CO₂-free inorganic solvent at a lower end of the absorber to the second spray unit and a sixth pump adapted for pumping the CO₂-free inorganic solvent separated by the nanofiltration unit back to the second spray unit.
9. The apparatus of item 8, further including a seventh pump, adapted for pumping the inorganic acid from the anolyte tank to the mixing tank and an eighth pump, adapted for pumping regenerated anolyte from the mixing tank to the anolyte tank.
10. The apparatus of item 9, further including (a) a first condenser connected to the anolyte tank and adapted for condensing water vapor from an oxygen discharge stream, (b) a second condenser connected to the catholyte tank and adapted for condensing water vapor from a hydrogen discharge stream and (c) a ninth pump adapted for pumping condensed water from the first condenser to the second condenser.
11. The apparatus of item 10, further including (a) a first heating element, in the anolyte tank, adapted for heating the anolyte to a temperature of about 100° C. and (b) a second heating element, in the catholyte tank, adapted for heating the catholyte to a temperature of about 70° C.
12. The apparatus of item 5, further including a control system including a controller adapted to (a) receive data from a plurality of pressure sensors, a plurality of pressure regulators and a plurality of pH sensors and (b) control operation of the first, second, third, fourth, fifth, sixth, seventh, eighth and ninth pumps in response to the data.
13. The apparatus of item 5, further including (a) a first heating element, in the anolyte tank, adapted for heating the anolyte to a temperature of about 100° C. and (b) a second heating element, in the catholyte tank, adapted for heating the catholyte to a temperature of about 70° C.
14. The apparatus of item 13, wherein the electrochemical unit is a sulfate-based electrochemical flow cell.
15. A method of capturing carbon dioxide from an acid gas, comprising:
   generating an inorganic acid and a CO₂-free inorganic solvent with an electrochemical unit;
   capturing the carbon dioxide in the acid gas as a CO₂-rich inorganic solvent in an absorber using the CO₂-free inorganic solvent from the electrochemical unit; and
   mixing the inorganic acid from the electrochemical unit with the CO₂-rich inorganic solvent from the absorber, and releasing carbon dioxide by acid-base neutralization in a mixing unit.
16. The method of item 15, further including separating remaining CO₂-free inorganic solvent from the CO₂-rich inorganic solvent discharged from the absorber in a nanofiltration unit prior to circulating the CO₂-rich inorganic solvent to the mixing unit.
17. The method of item 16, further including recirculating the CO₂-free inorganic solvent separated by the nanofiltration unit back to the absorber.
18. The method of item 17, including spraying the CO₂-free inorganic solvent from the electrochemical unit from a first spray unit in the absorber and spraying the CO₂-free inorganic solvent separated by the nanofiltration unit from a second spray unit in the absorber.
19. The method of item 18, including using a sulfate-based electrochemical flow cell as the electrochemical unit.
20. The method of item 19, including (a) heating anolyte in an anolyte tank to a temperature of about 100° C. and (b) heating catholyte in a catholyte tank to a temperature of about 70° C.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a catolyte”, as used herein, may also refer to, and encompass, a plurality of catolytes.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the apparatus and method of capturing carbon dioxide from an untreated gas stream of this disclosure have been illustratively described and presented by way of specific exemplary embodiments, and examples thereof, it is evident that many alternatives, modifications, or/and variations, thereof, will be apparent to those skilled in the art. For example, the anode 22 and/or cathode 24 may be made from titanium sheet or mesh coated with a catalyst layer such as iridium, ruthenium, platinum, and/or tantalum, that can facilitate gas evolution reactions or acid and base productions. Accordingly, it is intended that all such alternatives, modifications, or/and variations, fall within the spirit of, and are encompassed by, the broad scope of the appended claims.

What is claimed:

1. An apparatus for capturing carbon dioxide from an untreated gas stream, comprising:
an electrochemical unit adapted for generating an inorganic acid and a CO₂-free inorganic solvent;
an absorber in communication with the electrochemical unit, the absorber adapted for receiving the untreated gas stream and the CO₂-free inorganic solvent and capturing the carbon dioxide in the untreated gas stream as a CO₂-rich inorganic solvent; and
a mixing tank in communication with the electrochemical unit and the absorber, the mixing tank adapted for mixing the inorganic acid, received from the electrochemical unit, with the CO₂-rich inorganic solvent, received from the absorber, and releasing carbon dioxide by acid-base neutralization.

2. The apparatus of claim 1, further including a nanofiltration unit between the absorber and the mixing tank, the nanofiltration unit being adapted to (a) separate the CO₂-rich inorganic solvent received from the absorber and (b) direct the CO₂-rich inorganic solvent to the mixing tank and the CO₂-free or CO₂-lean inorganic solvent back to the absorber.

3. The apparatus of claim 2, further including a first spray unit in the absorber adapted for receiving and spraying the CO₂-free inorganic solvent from the electrochemical unit and a second spray unit in the absorber adapted for receiving and spraying the CO₂-free inorganic solvent from the nanofiltration unit.

4. The apparatus of claim 3, wherein the electrochemical unit includes (a) an anode, (b) a cathode, (c) a cation exchange membrane separating the anode from the cathode and (d) a voltage source connected to the anode and the cathode.

5. The apparatus of claim 4, wherein the electrochemical unit further includes (a) an anolyte tank and (b) a first pump adapted for circulating an anolyte from the anolyte tank across the anode and back to the anolyte tank.

6. The apparatus of claim 5, wherein the electrochemical unit further includes (a) a catholyte tank and (b) a second pump adapted for circulating a catholyte from the catholyte tank across the cathode and back to the catholyte tank.

7. The apparatus of claim 6, further including a third pump, adapted for pumping the CO₂-free inorganic solvent from the catholyte tank to the absorber, and a fourth pump, adapted for pumping CO₂-rich inorganic solvent from the absorber to the mixing tank.

8. The apparatus of claim 7, further including a fifth pump adapted for recirculating the CO₂-free inorganic solvent at a lower end of the absorber to the second spray unit and a sixth pump adapted for pumping the CO₂-free inorganic solvent separated by the nanofiltration unit back to the second spray unit.

9. The apparatus of claim 8, further including a seventh pump, adapted for pumping the inorganic acid from the anolyte tank to the mixing tank and an eighth pump, adapted for pumping regenerated anolyte from the mixing tank to the anolyte tank.

10. The apparatus of claim 9, further including (a) a first condenser connected to the anolyte tank and adapted for condensing water vapor from an oxygen discharge stream, (b) a second condenser connected to the catholyte tank and adapted for condensing water vapor from a hydrogen discharge stream and (c) a ninth pump adapted for pumping condensed water from the first condenser to the second condenser.

11. The apparatus of claim 10, further including (a) a first heating element, in the anolyte tank, adapted for heating the anolyte to a temperature of about 100° C. and (b) a second heating element, in the catholyte tank, adapted for heating the catholyte to a temperature of about 70° C.

12. The apparatus of claim 5, further including a control system including a controller adapted to (a) receive data from a plurality of pressure sensors, a plurality of pressure regulators and a plurality of pH sensors and (b) control operation of the first, second, third, fourth, fifth, sixth, seventh, eighth and ninth pumps in response to the data.

13. The apparatus of claim 5, further including (a) a first heating element, in the anolyte tank, adapted for heating the anolyte to a temperature of about 100° C. and (b) a second heating element, in the catholyte tank, adapted for heating the catholyte to a temperature of about 70° C.

14. The apparatus of claim 13, wherein the electrochemical unit is a sulfate-based electrochemical flow cell.

15. A method of capturing carbon dioxide from an acid gas, comprising:
generating an inorganic acid and a CO₂-free inorganic solvent with an electrochemical unit;
capturing the carbon dioxide in the acid gas as a CO₂-rich inorganic solvent in an absorber using the CO₂-free inorganic solvent from the electrochemical unit; and
mixing the inorganic acid from the electrochemical unit with the CO₂-rich inorganic solvent from the absorber, and releasing carbon dioxide by acid-base neutralization in a mixing unit.

16. The method of claim 15, further including separating remaining CO₂-free inorganic solvent from the CO₂-rich inorganic solvent discharged from the absorber in a nanofiltration unit prior to circulating the CO₂-rich inorganic solvent to the mixing unit.

17. The method of claim 16, further including recirculating the CO₂-free inorganic solvent separated by the nanofiltration unit back to the absorber.

18. The method of claim 17, including spraying the CO₂-free inorganic solvent from the electrochemical unit from a first spray unit in the absorber and spraying the CO₂-free inorganic solvent separated by the nanofiltration unit from a second spray unit in the absorber.

19. The method of claim 18, including using a sulfate-based electrochemical flow cell as the electrochemical unit.

20. The method of claim 19, including (a) heating anolyte in an anolyte tank to a temperature of about 100° C. and (b) heating catholyte in a catholyte tank to a temperature of about 70° C.
